(19) United States
(12) Patent Application Publication
(10) Pub. No.: US 2023/0313021 A1
(43) Pub. Date: Oct. 5, 2023

(54) VINYL ALCOHOL-BASED POLYMER

(71) Applicant: DENKA COMPANY LIMITED, Tokyo (JP)

(72) Inventor: Akihiro YAMASHITA, Tokyo (JP)

(73) Assignee: DENKA COMPANY LIMITED, Tokyo (JP)

(21) Appl. No.: 18/011,736

(22) PCT Filed: Jul. 15, 2021
(86) PCT No.: PCT/JP2021/026687

§ 371 Date: Dec. 20, 2022

(30) Foreign Application Priority Data
Jul. 31, 2020 (JP) 2020-131222

(51) Int. Cl. C09K 8/487; C04B 24/26

(52) U.S. Cl. CPC C09K 8/487; C04B 24/2623; C04B 2103/46

(57) ABSTRACT

A vinyl alcohol-based polymer useful as an additive for oil well cement is provided. The vinyl alcohol-based polymer is produced by saponification of a homopolymer of a vinyl ester monomer or a copolymer of a vinyl ester monomer and a polyfunctional monomer, wherein the vinyl alcohol-based polymer has a difference between transmittance (A) of 1 mass % aqueous solution at 660 nm and transmittance (B) of 1 mass % aqueous solution at 430 nm, i.e. (A-B), of 5 to 25. It is preferable that 1 mass % aqueous solution of the vinyl alcohol-based polymer have a transmittance of 95% or less in an entire wavelength region of 200 nm to 800 nm, and the vinyl alcohol-based polymer have a yellow index of 10 or less.

### TECHNICAL FIELD

The present invention relates to a vinyl alcohol-based polymer useful as an additive for oil well cement.

### BACKGROUND ART

An oil well cement used for cementing oil wells, gas wells, steam wells for geothermal power generation, etc. is filled in a gap between a steel pipe or casing and a well to protect the steel pipe or casing. Due to high pressure at the time of injection and heat in the ground, the water content in the cement slurry is lost (fluid loss), which reduces the fluidity of the cement slurry and the strength after curing. Accordingly, a fluid loss reducing agent is added.

It is known that a polyvinyl alcohol-based polymer (herein after referred to as PVA) is used as an example of the fluid loss reducing agent. In recent years, shale gas wells, in particular, have been mined deeper, so that pressure and temperature conditions have become more severe. The present countermeasure is to increase the amount of fluid loss reducing agent added. However, an increase in the amount of fluid loss reducing agent added causes thickening of the cement slurry, resulting in a decrease in fluidity and an increase in cost. Accordingly, the improved performance of the reducing agent itself for reducing fluid loss has been required.

Patent Literatures 1 and 2 disclose a conventional PVA for a fluid loss reducing agent. However, the performance of reducing fluid loss required for a cement slurry injected at high-temperature and high-pressure conditions is insufficient.

### CITATION LIST

### Patent Literature

### Patent Literature 1

International Publication No. WO 2007/146348

### Patent Literature 2

Japanese Patent Laid-Open No. 2015-196733

### SUMMARY OF INVENTION

### Technical Problem

An object of the present invention is to provide a vinyl alcohol-based polymer useful as an additive for oil well cement.

### Solution to Problem

The present invention can provide a vinyl alcohol-based polymer as a saponificated product of a homopolymer of a vinyl ester monomer or a copolymer of a vinyl ester monomer and a polyfunctional monomer, which has the difference between transmittance (A) of 1 mass % aqueous solution at 660 nm and transmittance (B) of 1 mass % aqueous solution at 430 nm, i.e. (A-B), of 5 to 25. It is preferable that 1 mass % aqueous solution of the vinyl alcohol-based polymer may have a transmittance of 95% or less in an entire wavelength region of 200 nm to 800 nm, and the vinyl alcohol-based polymer may have a yellow index of 10 or less. The vinyl alcohol-based polymer is useful as an additive for oil well cement.

### Advantageous Effects of Invention

According to the present invention, a vinyl alcohol-based polymer useful as an additive for oil well cement is provided.

### BRIEF DESCRIPTION OF DRAWINGS

FIG. 1 is a graph showing the transmittance of the vinyl alcohol-based polymer in the Examples in a wavelength range of 200 nm to 1000 nm.

FIG. 2 is a graph showing the transmittance of the vinyl alcohol-based polymer in the Comparative Examples in a wavelength range of 200 nm to 1000 nm.

### DESCRIPTION OF EMBODIMENT

Hereinafter, embodiments of the present invention will be described in detail. The present invention is not limited to the embodiments described below.

The present vinyl alcohol-based polymer of the present invention is a saponified product of a homopolymer of a vinyl ester monomer or a copolymer of a vinyl ester monomer and a polyfunctional monomer, which has the difference between transmittance (A) of 1 mass % aqueous solution at 660 nm and transmittance (B) of 1 mass % aqueous solution at 430 nm, i.e. (A-B), of 5 to 25.

Examples of the vinyl ester monomer may include vinyl acetate, vinyl propionate, vinyl butyrate, vinyl valerate, vinyl caprate, vinyl laurate, vinyl stearate, vinyl benzoate, vinyl pivalate, and a mixture thereof may be used. Vinyl acetate may be preferred from the viewpoint of easy polymerization.

The polyfunctional monomer copolymerizable with the vinyl ester monomer may include a compound having two or more polymerizable unsaturated bonds in the molecule. Examples thereof may include a divinyl ether such as ethanediol divinyl ether, propanediol divinyl ether, butanediol divinyl ether, ethylene glycol divinyl ether, diethylene glycol divinyl ether, triethylene glycol divinyl ether, polyethylene glycol divinyl ether, propylene glycol divinyl ether, and polypropylene glycol divinyl ether, and a divinyl sulfonic acid compound.

Examples thereof may further include: a diene compound such as pentadiene, hexadiene, heptadiene, octadiene, nonadiene, and decadiene; a diallyl ether compound such as glycerol diallyl ether, diethylene glycol diallyl ether, ethylene glycol diallyl ether, triethylene glycol diallyl ether, polyethylene glycol diallyl ether, trimethylolpropane diallyl ether, and pentaerythritol diallyl ether; a triallyl ether compound such as glycerol triallyl ether, trimethylolpropane triallyl ether, and pentaerythritol triallyl ether; a tetraallyl ether compound such as pentaerythritol tetraallyl ether; a monomer containing an allyl ester group such as diallyl phthalate, diallyl maleate, diallyl itaconate, diallyl terephthalate, and diallyl adipate; a diallylamine compound such as diallylamine and diallylmethylamine, and a monomer containing an allylamino group such as triallylamine; a monomer containing an allylammonium group such as a diallylammonium salt such as diallyldimethylammonium chloride; and a monomer containing two or more allyl groups such as triallyl isocyanurate, 1,3-diallyl urea, triallyl phosphate, and diallyl disulfide.

Examples thereof may further include: a monomer having (meth)acrylic acid such as ethylene glycol di(meth)acrylate, diethylene glycol di(meth)acrylate, triethylene glycol di(meth)acrylate, polyethylene glycol di(meth)acrylate, propylene glycol di(meth)acrylate, polypropylene glycol di(meth)acrylate, glycerol di(meth)acrylate, glycerol tri(meth)acrylate, pentaerythritol tri(meth)acrylate, trimethylol propane tri(meth)acrylate, ditrimethylol propane tetra(meth)acrylate, pentaerythritol tetra(meth)acrylate, dipentaerythritol hexa(meth)acrylate, and isocyanuric acid tri(meth)acrylate; a monomer having (meth)acrylamide such as N,N′-methylene bis(meth)acrylamide and N,N′-ethylene bis(meth)acrylamide; and divinylbenzene and trivinylbenzene.

From the viewpoint of reactivity with a vinyl ester monomer and resistance to decomposition in a saponification reaction, a compound having a carbonyl group or an amide group in the molecule is more preferred among these compounds, and use of triallyl isocyanurate may particularly be preferred.

Regarding the amount of copolymerization in copolymerization of a polyfunctional monomer, relative to 100 mol % of the structural unit derived from the vinyl alcohol unit in the vinyl alcohol-based polymer, the amount of the structural unit derived from the polyfunctional monomer is controlled to preferably 0.001 to 1.0 mol %, more preferably 0.005 to 0.5 mol %, and still more preferably 0.01 to 0.2 mol %. Through adjustment of the amount of polyfunctional monomer copolymerized to such a range, the effect of reducing fluid loss is sufficiently obtained, and the resulting vinyl alcohol-based polymer is not excessively crosslinked, so that workability is not worsened.

The amount of the polyfunctional monomer copolymerized may be calculated using a trace total nitrogen analyzer TN-2100H (manufactured by Nittoseiko Analytech Co., Ltd.) by the following procedure.

A sample of vinyl alcohol-based polymer is collected on a quartz board, set in an auto boat controller ABC-210 (manufactured by Nittoseiko Analytech Co., Ltd.), automatically put in an electric furnace, and burnt in an argon/oxygen stream. NO gas generated on this occasion is measured by a chemiluminescence detector. A calibration curve is prepared in advance with use of a standard solution (N-pyridine/toluene), and the nitrogen concentration is calculated from the calibration curve.

Measurement Condition

Reaction tube: Double tube for ABC

Electric Furnace Temperature

Inlet Temp: 800° C., Outlet Temp: 900° C.

Gas flow rate: Ar: 300 mL/min, O₂: 300 mL/min, Ozone: 300 mL/min

Amount of sample: approximately 9 to 15 mg

The method for polymerization of the vinyl ester monomer or the vinyl ester monomer and a polyfunctional monomer is not particularly limited, and a known polymerization method such as solution polymerization, suspension polymerization, and bulk polymerization may be used. From the viewpoint of easy operation and using a solvent common to a saponification reaction in the subsequent step, use of solution polymerization method in alcohol is preferred, and use of methanol as the alcohol is particularly preferred.

The vinyl alcohol-based polymer of the present invention is prepared through saponification of the homopolymer of vinyl ester monomer or the copolymer of a vinyl ester monomer and a polyfunctional monomer obtained by the method described above.

The saponification reaction is performed by dissolving the homopolymer of vinyl ester monomer or the copolymer of a vinyl ester monomer and a polyfunctional monomer in alcohol, and adding an alkali catalyst or an acid catalyst thereto. Examples of the alcohol include methanol, ethanol and butanol. Use of methanol is particularly preferred, because the solvent is common to the polymerization method. The concentration of the homopolymer of vinyl ester monomer or the copolymer of a vinyl ester monomer and a polyfunctional monomer in alcohol is preferably 5 to 80% in terms of solid content. Examples of the alkali catalyst for use include an alkali metal hydroxide and an alcoholate such as sodium hydroxide, potassium hydroxide, sodium methylate, sodium ethylate, and potassium methylate. Examples of the acid catalyst for use include an aqueous solution of inorganic acid such as chloric acid and sulfuric acid, and an organic acid such as p=toluene sulfonic acid. The usage of the catalyst is preferably 0.1 to 100 mmol equivalent relative to the vinyl ester monomer unit. The reaction temperature during saponification preferably in the range of 10 to 70° C., more preferably in the range of 30 to 50° C. The reaction time is preferably 1 to 10 hours.

It is preferable that the degree of saponification of the vinyl alcohol-based polymer be 70 to 99 mol %. With a degree of saponification controlled to the range, sufficient effect of reducing fluid loss is achieved. From the viewpoint of the effect of reducing fluid loss, the degree of saponification is more preferably 75 to 98 mol %. The “degree of saponification” in the present specification means a value calculated from the measurement in accordance with JIS K 6726, section 3.5 “Degree of Saponification”.

The vinyl alcohol-based polymer of the present invention has the difference between transmittance (A) of 1 mass % aqueous solution at 660 nm and transmittance (B) of 1 mass % aqueous solution at 430 nm, i.e. (A-B), of 5 to 25. The reduction of the transmittance is caused mainly by absorption and scattering of light. The transmittance at 660 nm is generally an index indicating turbidity. The light irradiated to a turbid liquid is scattered by particles in the turbid liquid, so that the transmitted light is reduced. That is, the value of the transmittance at 660 nm depends on the amount of fine particles present as crosslinked vinyl alcohol-based polymer insoluble in water. The particles cause more scattering as the amount of fine particles present therein increases, so that the value of the transmittance decreases. On the other hand, the value of the transmittance at 430 nm depends on scattering and absorption. In the present invention, it has been found that the presence of crosslinked PVA fine particles insoluble in water which cause scattering at these wavelengths is important for the effect of reducing fluid loss. In a general linear chain PVA uniformly dissolved in water, the difference in transmittance (A-B) is less than 5, because there is almost no scattering in a 1% aqueous solution. On the other hand, with the difference in transmittance (A-B) of more than 25, a gel that causes adhesion is generated, resulting in extremely difficult production.

The 1 mass % aqueous solution of vinyl alcohol-based polymer of the present invention has a transmittance of preferably 95% or less, more preferably 93% or less, and still more preferably 90% or less in an entire wavelength region of 200 nm to 800 nm. The value of the transmittance in an entire wavelength region of 200 nm to 800 nm depends on the scattering by the vinyl alcohol-based polymer in water, and means the presence of fine particles of the crosslinked vinyl alcohol-based polymer causing scattering in the entire wavelength region. The vinyl alcohol-based polymer causing scattering in the entire wavelength region reduces the fluid loss, and through adjustment to the range, the effect of reducing fluid loss is improved. In order to obtain a suitable transmittance in the entire wavelength region of 200 nm to 800 nm, the amount of copolymerization with the polyfunctional comonomer and the conversion of the monomer may be appropriately adjusted.

The transmittance of the vinyl alcohol-based polymer may be measured by the following procedure. The transmittance (% T) in the region of 200 to 1000 nm of an aqueous solution of vinyl alcohol-based polymer adjusted to 1 mass % in a 20 mm quartz cell is measured with a UV meter (UV-1800, manufactured by Shimadzu Corporation).

The yellow index of the vinyl alcohol-based polymer of the present invention is preferably 10 or less, more preferably 8 or less. The yellow index is an index representing the yellowness of a vinyl alcohol-based polymer. The vinyl alcohol-based polymer having a high yellow index contains a low-molecular-weight vinyl alcohol-based polymer. Since the presence of a low-molecular-weight vinyl alcohol-based polymer is not preferable from the viewpoint of the effect of reducing fluid loss, it is preferable that the yellow index be adjusted to the range. The value of the yellow index may be adjusted by the degree of saponification, the amount of the polyfunctional monomer copolymerized, the amount of the solvent in polymerization, etc.

The yellow index may be measured by the following procedure. The value of XYZ colorimetric system of the vinyl alcohol-based polymer in powder state may be obtained using a colorimetric color difference meter (ZE 2000, Nippon Denshoku Industries Co., Ltd.). The value of YI may be calculated based on JIS K7373: 2006 Plastics-Determination of yellowness index and change of yellowness index, 6. Calculation method with use of auxiliary illuminant C.

The vinyl alcohol-based polymer of the present invention may be copolymerized with a vinyl ester monomer or another monomer copolymerizable with the polyfunctional monomer as long as the effect of the present invention is not impaired. Examples of the other monomer include an α-olefin monomer such as ethylene and propylene; a (meth)acrylic acid alkyl ester monomer such as methyl (meth)acrylate, ethyl (meth)acrylate, butyl (meth)acrylate, and 2-ethylhexyl (meth) acrylate; an unsaturated amide monomer such as (meth)acrylamide and N-methylol acrylamide; an unsaturated carboxylic acid monomer such as (meth)acrylic acid, crotonic acid, maleic acid, itaconic acid, and fumaric acid; an alkyl (methyl, ethyl, propyl, etc.) ester monomer of unsaturated carboxylic acid; an anhydride of unsaturated carboxylic acid such as maleic anhydride; a salt of unsaturated carboxylic acid with sodium, potassium, ammonium, etc.; a glycidyl group-containing monomer such as allyl glycidyl ether and glycidyl (meth)acrylate; a sulfonic acid group-containing monomer such as 2-acrylamide-2-methylpropanesulfonic acid or a salt thereof; a phosphate group-containing monomer such as acid phosphooxyethyl methacrylate and acid phosphooxypropyl methacrylate, and an alkyl vinyl ether monomer.

The viscosity average degree of polymerization of the vinyl alcohol-based polymer is preferably 1000 to 10000, more preferably 1500 to 6000, and still more preferably 2000 to 5000. With the viscosity average degree of polymerization adjusted to the ranges, a sufficient effect of reducing fluid loss may be obtained, and the cement slurry is not made highly viscous, so that the fluidity does not decrease.

The “viscosity average degree of polymerization” is a value calculated by the following formula (1), based on the limiting viscosity [η] (g/dL) measured at 30° C. with an Ostwald viscometer using ion-exchanged water as solvent.

log(P)=1.613×log([η]×104/8.29) (1)

Here, P represents the viscosity average degree of polymerization.

The vinyl alcohol-based polymer of the present invention is suitably used as an additive for oil well cement. The method of adding the vinyl alcohol-based polymer to the cement slurry is not particularly limited, and a conventional method such as mixing with a dry cement composition in advance, and mixing during forming a cement slurry may be used.

The amount of the vinyl alcohol-based polymer added is 0.01 to 30% bwoc. The amount is preferably 0.05 to 10% bwoc, more preferably 0.1 to 5% bwoc. Herein, the term “by weight of cement” (bwoc) refers to the weight of a dry additive added to a cement composition based on the solid content of cement only.

### EXAMPLES

Although the present invention will be described in more detail based on Examples as follows, the present invention is not limited thereto. Hereinafter, unless otherwise specified, “part” and “%” means “part by mass” and “mass %”, respectively.

### Preparation of PVA

### Example 1

A polymerization can equipped with a reflux condenser, a dropping funnel, and a stirrer was charged with 100 parts by mass of vinyl acetate, 0.16 parts by mass of triallyl isocyanurate, 67.0 parts by mass of methanol, and 0.005 parts by mass of Peroyl NPP (manufactured by NOF Corporation), and polymerization was performed at a boiling point for 5 hours while stirring in a nitrogen stream. The polymerization was stopped when the conversion of vinyl acetate reached 50%, and an unreacted vinyl acetate monomer was removed from the polymerization system by a conventional method to obtain a methanol solution of vinyl acetate resin.

To the resulting methanol solution of vinyl acetate resin, a methanol solution of sodium hydroxide (0.01 mol equivalent of sodium hydroxide relative to vinyl acetate) was added to perform a saponification reaction at 45° C. for 50 minutes. The resulting reaction solution was dried by heating to obtain PVA having a saponification degree of 80 mol % in Example 1. Measurement and calculation of the “degree of saponification” were performed in accordance with Japanese Industrial Standard, JIS K 6726, section 3.5 “Degree of Saponification”.

The dried PVA was subjected to primary pulverizing with a pulverizer and then sieved using a sieve having an opening of 500 μm. The particles on the sieve were pulverized again with a pulverizer and mixed well with the particles under the sieve. PVA having a particle size adjusted to 500 μm or more at 0.1 mass %, and 75 μm or less at 12.4 mass % was obtained. In a preliminary test, the time period until the proportion of particles having a size of 500 μm or more reached 30 mass % or less in the primary pulverizing, and the approximate time period until the proportion of particles having a size of 500 μm or more reached 5 mass % or less in the re-pulverizing of the particles on the sieve, were checked. The pulverizing was performed for each of the time periods.

### Example 2

PVA was obtained by the same procedure as in Example 1 except that using the methanol solution of vinyl acetate resin obtained in Example 1, the amount of methanol solution of sodium hydroxide added thereto was adjusted to have a degree of saponification of PVA of 88 mol %.

The dried PVA was subjected to particle size adjustment with a pulverizer as in Example 1, such that the particle size was adjusted to 500 μm or more at 0.2 mass % and 75 μm or less at 10.5 mass %.

### Example 3

PVA was obtained in the same manner as in Example 1, except that using the methanol solution of the vinyl acetate resin obtained in Example 1, the saponification degree of PVA was changed to 98 mol %.

The dried PVA was subjected to particle size adjustment with a pulverizer as in Example 1, and PVA having a particle size adjusted to 500 μm or more at 0.1 mass % and 75 μm or less at 13.8 mass % was obtained.

### Example 4

A polymerization can equipped with a reflux condenser, a dropping funnel, and a stirrer was charged with 100 parts by mass of vinyl acetate, 0.33 parts by mass of triallyl isocyanurate, 150.0 parts by mass of methanol, and 0.013 parts by mass of Peroyl NPP (manufactured by NOF Corporation), and polymerization was performed at a boiling point for 5 hours while stirring in a nitrogen stream. The polymerization was stopped when the conversion of vinyl acetate reached 69%, and an unreacted vinyl acetate monomer was removed from the polymerization system by a conventional method to obtain a methanol solution of vinyl acetate resin.

To the resulting methanol solution of vinyl acetate resin, a methanol solution of sodium hydroxide (0.01 mol equivalent of sodium hydroxide relative to vinyl acetate) was added to perform a saponification reaction at 45° C. for 50 minutes. The resulting reaction solution was dried by heating to obtain PVA having a saponification degree of 80 mol % in Example 4.

The dried PVA was subjected to primary pulverizing with a pulverizer and then sieved using a sieve having an opening of 500 μm. The particles on the sieve was pulverized again with a pulverizer and mixed well with the particles under the sieve. PVA having a particle size adjusted to 500 μm or more at 0.1 mass % and 75 μm or less at 10.8 mass % was obtained.

### Example 5

A polymerization can equipped with a reflux condenser, a dropping funnel, and a stirrer was charged with 100 parts by mass of vinyl acetate, 0.04 parts by mass of triallyl isocyanurate, 21.0 parts by mass of methanol, and 0.003 parts by mass of Peroyl NPP (manufactured by NOF Corporation), and polymerization was performed at a boiling point for 5 hours while stirring in a nitrogen stream. The polymerization was stopped when the conversion of vinyl acetate reached 50%, and an unreacted vinyl acetate monomer was removed from the polymerization system by a conventional method to obtain a methanol solution of vinyl acetate resin.

To the resulting methanol solution of vinyl acetate resin, a methanol solution of sodium hydroxide (0.012 mol equivalent of sodium hydroxide relative to vinyl acetate) was added to perform a saponification reaction at 45° C. for 50 minutes. The resulting reaction solution was dried by heating to obtain PVA having a saponification degree of 80 mol % in Example 5.

The dried PVA was subjected to particle size adjustment with a pulverizer as in Example 1, and PVA having a particle size adjusted to 500 μm or more at 0.1 mass % and 75 μm or less at 11.2 mass % was obtained.

### Example 6

A polymerization can equipped with a reflux condenser, a dropping funnel, and a stirrer was charged with 100 parts by mass of vinyl acetate, 0.09 parts by mass of triallyl isocyanurate, 43.0 parts by mass of methanol, and 0.04 parts by mass of Peroyl NPP (manufactured by NOF Corporation), and polymerization was performed at a boiling point for 5 hours while stirring in a nitrogen stream. The polymerization was stopped when the conversion of vinyl acetate reached 55%, and an unreacted vinyl acetate monomer was removed from the polymerization system by a conventional method to obtain a methanol solution of vinyl acetate resin.

To the resulting methanol solution of vinyl acetate resin, a methanol solution of sodium hydroxide (0.01 mol equivalent of sodium hydroxide relative to vinyl acetate) was added to perform a saponification reaction at 45° C. for 90 minutes. The resulting reaction solution was dried by heating to obtain PVA having a saponification degree of 81.0 mol % in Example 6.

The dried PVA was subjected to particle size adjustment with a pulverizer as in Example 1, such that the particle size was adjusted to 500 μm or more at 0.1 mass % and 75 μm or less at 12.1 mass %.

### Comparative Example 1

A polymerization can equipped with a reflux condenser, a dropping funnel, and a stirrer was charged with 100 parts by mass of vinyl acetate, 22.0 parts by mass of methanol, and 0.0013 parts by mass of Peroyl NPP (manufactured by NOF Corporation), and polymerization was performed at a boiling point for 7 hours while stirring in a nitrogen stream. The polymerization was stopped when the conversion of vinyl acetate reached 69%, and an unreacted vinyl acetate monomer was removed from the polymerization system by a conventional method to obtain a methanol solution of vinyl acetate resin.

To the resulting methanol solution of vinyl acetate resin, a methanol solution of sodium hydroxide (0.013 mol equivalent of sodium hydroxide relative to vinyl acetate) was added to perform a saponification reaction at 45° C. for 50 minutes. The resulting reaction solution was dried by heating to obtain PVA having a saponification degree of 99 mol % in Comparative Example 1.

The dried PVA was subjected to particle size adjustment with a pulverizer as in Example 1, and PVA having a particle size adjusted to 500 μm or more at 0.1 mass % and 75 μm or less at 13.8 mass % was obtained.

### Comparative Example 2

A polymerization can equipped with a reflux condenser, a dropping funnel, and a stirrer was charged with 100 parts by mass of vinyl acetate, 67.0 parts by mass of methanol, and 0.015 parts by mass of Peroyl NPP (manufactured by NOF Corporation), and polymerization was performed at a boiling point for 10 hours while stirring in a nitrogen stream. The polymerization was stopped when the conversion of vinyl acetate reached 90%, and an unreacted vinyl acetate monomer was removed from the polymerization system by a conventional method to obtain a methanol solution of vinyl acetate resin.

To the resulting methanol solution of vinyl acetate resin, a methanol solution of sodium hydroxide (0.018 mol equivalent of sodium hydroxide relative to vinyl acetate) was added to perform a saponification reaction at 45° C. for 90 minutes. The resulting reaction solution was dried by heating to obtain PVA having a saponification degree of 98 mol % in Comparative Example 2.

The dried PVA was subjected to particle size adjustment with a pulverizer as in Example 1, and PVA having a particle size adjusted to 500 μm or more at 0.2 mass % and 75 μm or less at 11.1 mass % was obtained.

### Comparative Example 3

A polymerization can equipped with a reflux condenser, a dropping funnel, and a stirrer was charged with 100 parts by mass of vinyl acetate, 2.7 parts by mass of dimethylmaleic acid (DMM), 50.4 parts by mass of methanol, and 0.018 parts by mass of Peroyl NPP (manufactured by NOF Corporation), and polymerization was performed at a boiling point for 9 hours while stirring in a nitrogen stream. The polymerization was stopped when the conversion of vinyl acetate reached 92%, and an unreacted vinyl acetate monomer was removed from the polymerization system by a conventional method to obtain a methanol solution of vinyl acetate resin.

To the resulting methanol solution of vinyl acetate resin, a methanol solution of sodium hydroxide (0.014 mol equivalent of sodium hydroxide relative to vinyl acetate) was added to perform a saponification reaction at 45° C. for 50 minutes. The resulting reaction solution was dried by heating to obtain PVA having a saponification degree of 72 mol % in Comparative Example 3.

The dried PVA was subjected to particle size adjustment with a pulverizer as in Example 1, and PVA having a particle size adjusted to 500 μm or more at 0.1 mass % and 75 μm or less at 12.2 mass % was obtained.

### Comparative Example 4

A polymerization can equipped with a reflux condenser, a dropping funnel, and a stirrer was charged with 100 parts by mass of vinyl acetate, 0.16 parts by mass of triallyl cyanurate (TAC), 67.0 parts by mass of methanol, and 0.003 parts by mass of Peroyl NPP (manufactured by NOF Corporation), and polymerization was performed at a boiling point for 5 hours while stirring in a nitrogen stream. The polymerization was stopped when the conversion of vinyl acetate reached 45%, and an unreacted vinyl acetate monomer was removed from the polymerization system by a conventional method to obtain a methanol solution of vinyl acetate resin.

To the resulting methanol solution of vinyl acetate resin, a methanol solution of sodium hydroxide (0.01 mol equivalent of sodium hydroxide relative to vinyl acetate) was added to perform a saponification reaction at 45° C. for 50 minutes. The resulting reaction solution was dried by heating to obtain PVA having a saponification degree of 80 mol % in Comparative Example 4.

The dried PVA was subjected to particle size adjustment with a pulverizer as in Example 1, and PVA having a particle size adjusted to 500 μm or more at 0.1 mass % and 75 μm or less at 12.7 mass % was obtained.

### 4% Viscosity

The viscosity of each of PVA obtained in Examples 1 to 6 and Comparative Examples 1 to 4 was measured in accordance with JIS K6726. As the measurement sample, an aqueous solution adjusted to 4 mass % was used.

### Amount of Polyfunctional Monomer Copolymerized in PVA

The amount of polyfunctional monomer copolymerized in the resulting PVA in Examples 1 to 6 and Comparative Examples 1 to 4 was calculated by the following method. The amount of polyfunctional monomer copolymerized was calculated using a trace total nitrogen analyzer TN-2100H (manufactured by Nittoseiko Analytech Co., Ltd.), by the following procedure. A sample of vinyl alcohol-based polymer was collected on a quartz board, set in an auto boat controller ABC-210 (manufactured by Nittoseiko Analytech Co., Ltd.), automatically put in an electric furnace, and burnt in an argon/oxygen stream. NO gas generated on this occasion was measured by a chemiluminescence detector. A calibration curve was prepared in advance with use of a standard solution (N-pyridine/toluene), and the nitrogen concentration was calculated from the calibration curve.

### Measurement Condition:

Reaction tube: Double tube for ABC

Electric Furnace Temperature

Inlet Temp: 800° C., Outlet Temp: 900° C.

Gas flow rate: Ar: 300 mL/min, O₂: 300 mL/min, Ozone: 300 mL/min

Amount of sample: approximately 9 to 15 mg

### Difference in Transmittance

An aqueous solution adjusted to 1 mass % of PVA obtained in each of Examples 1 to 6 and Comparative Examples 1 to 4 was placed in a 20-mm quartz cell to measure transmittance (% T) in the region of 200 to 1000 nm with a UV meter (UV-1800, manufactured by Shimadzu Corporation). From the resulting value of the transmittance (A) at 660 nm and the value of the transmittance (A) at 430 nm, the difference in transmittance was obtained.

### YI (Yellow Index)

The PVA obtained in each of Examples 1 to 6 and Comparative Examples 1 to 4 was subjected to measurement of YI (yellow index). The yellow index was measured by the following procedure. The value of XYZ colorimetric system of the vinyl alcohol-based polymer in powder state was obtained using a colorimetric color difference meter (ZE 2000, manufactured by Nippon Denshoku Industries Co., Ltd.). The value of YI was calculated based on JIS K7373: 2006 Plastics-Determination of yellowness index and change of yellowness index, 6. Calculation method with use of auxiliary illuminant C.

### Measurement of Fluid Loss

The effect of reduction in fluid loss of PVA was measured in accordance with the fluid loss evaluation method in American Petroleum Institute (API) standard 10B-2 (April 2013 edition). The specific measurement procedure was as follows. A well cement in class G was blended with PVA in an amount described in Table 1 and 0.4% bwoc of a curing retarder (CR-270, manufactured by Flotek Industries), and water was mixed therewith according to the procedure described in American Petroleum Association (API) standard 10B-2 (April 2013 edition) to obtain a cement slurry having a water content of 30 mass %. The resulting cement slurry was put into a fluid loss evaluation tester (Model 7120, manufactured by Chandler Engineering), and subjected to a test according to the procedure described in American Petroleum Institute (API) Standard 10B-2 (April 2013 edition) at the temperature described in Table 1 under a pressure of 1000 psi to calculate the amount of fluid loss.

The results obtained are shown in Table 1.

TABLE 1

| | | | | | | | | | | Compar | Compar | Compar | Compar |
|---|---|---|---|---|---|---|---|---|---|---|---|---|---|
| | | | | | | | | | | ative | ative | ative | ative |
| | | | | Exam- | Exam- | Exam- | Exam- | Exam- | Exam- | Exam- | Exam- | Exam- | Exam- |
| | | | | ple 1 | ple 2 | ple 3 | ple 4 | ple 5 | ple 6 | Example 1 | ple 2 | ple 3 | ple 4 |
| Charge | | Vinyl acetate | [Part] | 100 | 100 | 100 | 100 | 100 | 100 | 100 | 100 | 100 | 100 |
| | | Methanol | [Part] | 67 | 67 | 67 | 150 | 21 | 43 | 22 | 67 | 50.4 | 67 |
| | | Polyfunctional | Type | TAIC | TAIC | TAIC | TAIC | TAIC | TAIC | — | — | DMM | TAC |
| | | monomer | [Part] | 0.16 | 0.16 | 0.16 | 0.33 | 0.04 | 0.09 | — | — | 2.7 | 0.16 |
| | | Conversion of | [%] | 50 | 52 | 51 | 69 | 50 | 55 | 69 | 90 | 92 | 45 |
| | | vinyl acetate | | | | | | | | | | | |
| Physical properties | | 4% Viscosity | [mPas] | 95 | 134 | 152 | 47 | 59 | 46.4 | 27 | 5 | 11 | 34 |
| of PVA | | Degree of | [mol %] | 80 | 88 | 98 | 80 | 80 | 81 | 99 | 98 | 72 | 80 |
| | | saponification | | | | | | | | | | | |
| | | Amount of | [mol %] | 0.094 | 0.10 | 0.10 | 0.16 | 0.020 | 0.053 | — | — | 1.6 | 0.08 |
| | | copolymerization | | | | | | | | | | | |
| | | Difference in | [% T] | 20.1 | 15.7 | 18.9 | 20.5 | 7.2 | 12.8 | 0.9 | 0.8 | 2.2 | 0.9 |
| | | transmittance % | | | | | | | | | | | |
| | | T(660-430) | | | | | | | | | | | |
| | | YI | | 4.9 | 5.2 | 5.6 | 5.7 | 4.7 | 4.2 | 5.7 | 15 | 16.7 | 4.6 |
| Particle size | | >500 μm | [mass %] | 0.1 | 0.2 | 0.1 | 0.1 | 0.1 | 0.1 | 0.1 | 0.2 | 0.1 | 0.1 |
| distribution | | <75 μm | [mass %] | 12.4 | 10.5 | 13.8 | 10.8 | 11.2 | 12.1 | 13.8 | 11.1 | 12.2 | 12.7 |
| | Temperature | | | | | | | | | | | | |
| | [°C.] | Amount of PVA added [w %] | | | | | | | | | | | |
| Fluid | 40 | 0.4 | [cc] | 31 | 18 | — | 28 | 26 | 45 | 522 | 1086 | 460 | 254 |
| Loss | 60 | 0.6 | [cc] | 36 | 24 | — | 34 | 28 | 98 | 614 | — | 780 | 631 |
| [mL] | 80 | 0.8 | [cc] | 42 | 32 | 45 | 44 | 32 | — | — | — | — | — |
| | 100 | 0.8 | [cc] | 44 | 35 | 46 | 71 | 356 | — | — | — | — | — |
| | 110 | 0.8 | [cc] | 49 | 42 | 63 | 92 | — | — | — | — | — | — |
| | 120 | 0.8 | [cc] | 760 | 96 | 160 | 780 | — | — | — | — | — | — |
| | 120 | 1.2 | [cc] | 98 | 30 | 38 | 660 | — | — | — | — | — | — |
| | 140 | 1.2 | [cc] | 188 | 45 | 58 | — | — | — | — | — | — | — |

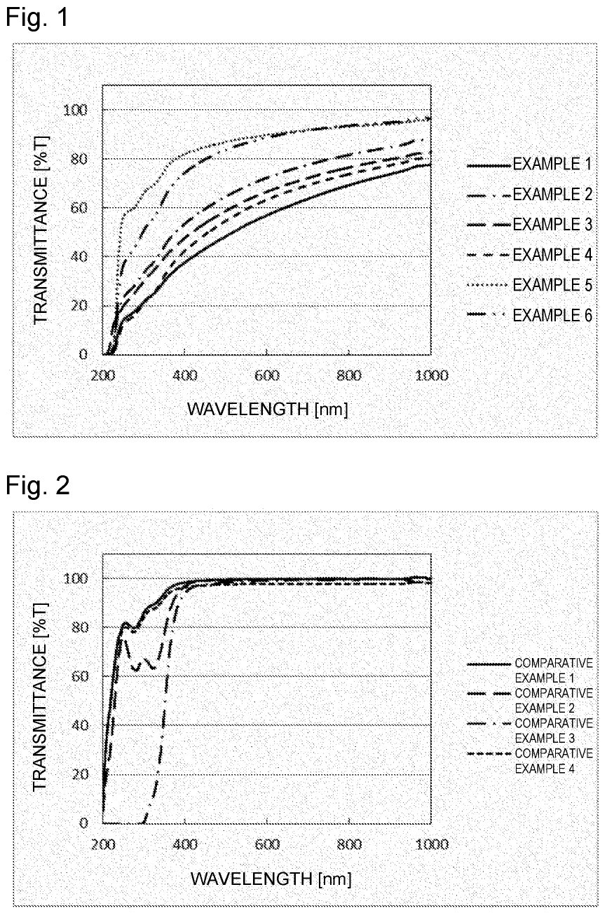

From the results in Table 1, it has been found that the additive for oil well cement containing PVA obtained in the present invention is able to greatly reduce the fluid loss of the oil well cement even at high temperature. FIG. 1 and FIG. 2 are graphs showing the transmittance of the vinyl alcohol-based polymers in Examples 1 to 6 and Comparative Examples 1 to 4, respectively, in a wavelength range of 200 nm to 1000 nm. As shown in FIG. 1, it has been found that the vinyl alcohol-based polymer of which 1 mass % aqueous solution has a transmittance of 95% or less in the entire wavelength region of 200 nm to 800 nm is able to greatly reduce the fluid loss of an oil well cement even at high temperature. In contrast, as shown in FIG. 2, the effect was not obtained in Comparative Examples.

1. A vinyl alcohol-based polymer, as a saponificated product of:
a homopolymer of a vinyl ester monomer, or
a copolymer of a vinyl ester monomer and a polyfunctional monomer,
wherein the vinyl alcohol-based polymer has a difference between transmittance (A) of 1 mass % aqueous solution at 660 nm and transmittance (B) of 1 mass % aqueous solution at 430 nm, i.e. (A-B), of 5 to 25.

2. The vinyl alcohol-based polymer according to claim 1, wherein a 1 mass % aqueous solution of the vinyl alcohol-based polymer has a transmittance of 95% or less in an entire wavelength region of 200 nm to 800 nm.

3. The vinyl alcohol-based polymer according to claim 1, wherein the vinyl alcohol-based polymer has a yellow index of 10 or less.

4. The vinyl alcohol-based polymer according to claim 1, wherein the vinyl alcohol-based polymer is an additive for oil well cement.
